(19) United States
(12) Patent Application Publication
(10) Pub. No.: US 2022/0330518 A1
(43) Pub. Date: Oct. 20, 2022

(54) PET CARRIER

(71) Applicant: Joy Tong, Boca Raton, FL (US)

(72) Inventor: Joy Tong, Boca Raton, FL (US)

(21) Appl. No.: 17/231,609

(22) Filed: Apr. 15, 2021

(51) Int. Cl. A01K 1/02; A01K 7/06

(52) U.S. Cl. CPC A01K 1/0254; A01K 7/06

(57) ABSTRACT

A pet carrier for carrying pets out is disclosed to include a drinking hole and a kettle holder provided on one side of a pet box that can be carried by hand or on the shoulder. The drinking hole is used to let the dip tube of a kettle insert into the inside of pet box to continuously supply drinking water to the pet. The kettle holder is an elastic belt for holding a kettle in place. When the pet box is not in use, the kettle holder will not hinder the folding and compression of the pet box.

### BACKGROUND OF THE INVENTION

### (a) Field of the Invention

The present invention relates to a pet carrier, especially a pet carrier suitable for carrying cats and dogs out.

### (b) Description of the Prior Art

The conventional pet carrier is a hard box made of plastic. For example, as shown in U.S. Patent Publication No. U.S. Pat. No. 8,132,537B2, its carrier body is a hard structure and cannot be compressed when not in use, causing a problem of occupying space. Therefore, most of the existing pet carriers use soft fabrics and are appropriately designed into a compressible structure. For example, U.S. Pat. No. 9,485,957B2 discloses a pet kennel that can be folded after being disassembled from the surrounding poles, but this combination method is more troublesome; US20080072837A1 discloses a foldable pet cage that can fold the two side panels inside on the bottom panel, and then fold the front and top panels on the top, but its back panel cannot be separated from the two side panels, so it may not be easy to keep flat after folding. The aforementioned soft fabric pet carrier design provides users with the convenience of taking cats and dogs out and storing, but it does not take into account the problem of pets having to supply drinking water during long-distance travel. Although U.S. Patent Publications U.S. Pat. Nos. 5,931,120A and 9,936,674B1 have spaces or small bags for storing pet water bottles in their carrier body, the pets must be released and the water poured in the bowl for pets to drink, so it is not easy to use on public transportation. In addition, U.S. Pat. No. 6,584,937B1 discloses a pet transport system for taking small and vulnerable pets on outings. It provides a water bottle combined with the inside of the pet box to supply drinking water. When the water bottle is installed or refilled, the pet box must be opened. At this time, the pet may jump out, and it is not very convenient to use, and it does not disclose how to fix the water bottle in the pet box. Although U.S. Patent Publication No. U.S. Pat. No. 6,484,667B2 discloses the use of springs to fit into the railings of pet cage, it is not suitable for use in soft fabric pet carriers, otherwise it will cause the problem of inability to compress and fold during storage.

In addition, when the pet carrier of soft fabric is carried by the user or carried on one shoulder, because of the downward pull of the weight and the pull up of the strap, as well as the relationship between it and the user, it is prone to collapse and deformation, which compresses the space for pet activities, therefore, must be further improved on the structure of the pet carrier's strap.

### SUMMARY OF THE INVENTION

It is a main object of the present invention to provide a pet carrier, which is provided with a drinking hole and a kettle holder on the side of a pet box that can be carried by hand or on the shoulder, so that the kettle can be easily fixed on the outer side of the pet box. In this way, the kettle can be easily set up without opening the pet box, and the dip tube of the kettle can penetrate the drinking hole into the pet box to continuously supply water to the pet.

It is another object of the present invention to provide a pet carrier, wherein the kettle holder is composed of an elastic belt, which can facilitate tightly fixing the kettle, and will not hinder the compression and folding of the pet box.

It is still another object of the present invention to provide a pet carrier, which uses a zipper chain to connect each phase surface structure, so that the pet box can be quickly fully unfolded and then folded and compressed together to save storage space.

Conversely, a three-dimensional pet box structure can be set up by using the zipper

It is still another object of the present invention to provide a pet carrier, wherein the two ends of each of two strap are respectively sleeved on the ends of two rod members, and the rod members respectively pass through a first arched piece and two second arched pieces on each of two opposite sides of the top surface of the pet box. This arrangement can achieve a stable lifting of the pet box, prevent the pet box from shaking back and forth, and also support the structure of the top surface of the pet box to prevent the pet box from collapsing and deforming.

### BRIEF DESCRIPTION OF THE DRAWINGS

FIG. 1 is an oblique top elevational view of a pet carrier in accordance with the present invention when viewed from a first side.

FIG. 2 is an oblique top elevational view of the pet carrier in accordance with the present invention when viewed from a second side.

FIG. 3 is an exploded view of the pet carrier in accordance with the present invention.

FIG. 4 is a schematic diagram of the unfolding action of the preferred embodiment of the pet carrier of the present invention.

FIG. 5 is a schematic diagram illustrating the preferred embodiment of the pet carrier of the present invention fully extended out.

FIG. 6 is a schematic diagram illustrating the collapsed status of the preferred embodiment of the pet carrier of the present invention.

FIG. 7 illustrates an alternate form of the kettle holder of the present invention.

### LED DESCRIPTION OF THE PREFERRED EMBODIMENTS

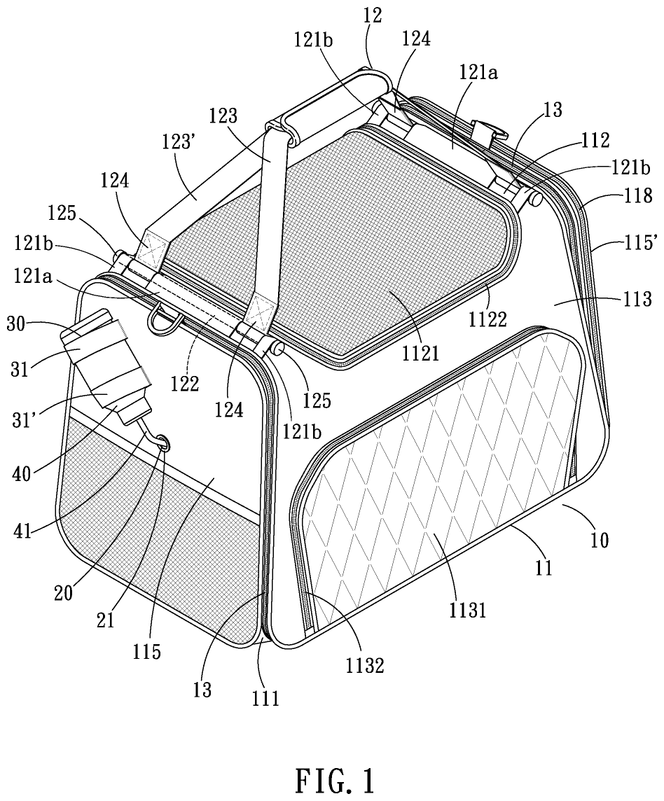

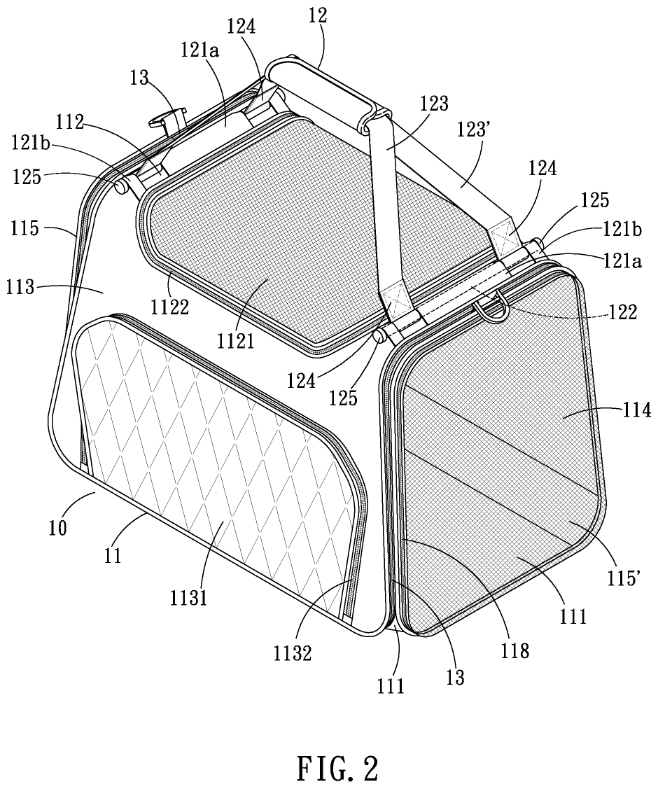

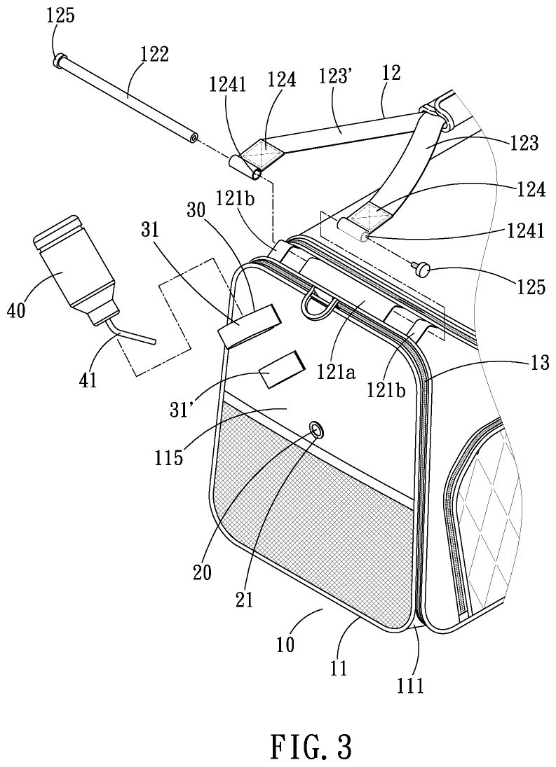

Referring to FIG. 1, FIG. 2 and FIG. 3, the pet carrier of the present invention is an outing bag used to carry pets such as cats and dogs out, and its preferred embodiment comprises a carrier body 10, a drinking hole 20 and a kettle holder 30. The carrier body 10 comprises a pet box 11 formed by stitching soft cloth sheets for placing pets therein, and a portable device 12 combined with the pet box 11.

The drinking hole 20, which is provided on one side of the carrier body 11 and connected to the inside of the pet box 11, is used to provide the user with a dip tube 41 of a kettle 40 extending into the carrier body 11 through the drinking hole 20. The edge of the drinking hole 30 can be covered with a metal ring 21 as required to fix the shape of the drinking hole 30.

The kettle holder 30 comprises at least one elastic belt 31, and the elastic belt 31 is preferably an elastic braided belt. The two ends of the elastic belt 31 after being folded in half are joined to the outer surface of the side of the pet box 11 with the drinking hole 20 by stitching or riveting structure, which is used to bind and fix the kettle 40. As illustrated in the drawings, the best implementation comprises two elastic belts 31,31′. The two elastic belts 31 and 31′ have different lengths, which are respectively folded in half, and the two ends are stitched or riveted on the outer surface of the side of the carrier body 10 to form an elastic belt 31 that has a larger diameter than the other elastic belt 31′, so that the kettle holder can adapt to kettles of different sizes.

In this way, the pet carrier of the present invention allows the user to set the kettle 40 on the side of the carrier body 10 and make the dip tube 41 extend into the carrier body 10 to continuously provide drinking water for pets when go out. Moreover, it can be observed at any time whether the water volume of the kettle 40 is sufficient, and the process of setting the kettle 40 or replenishing water does not need to open the carrier body 10, which is more convenient to use.

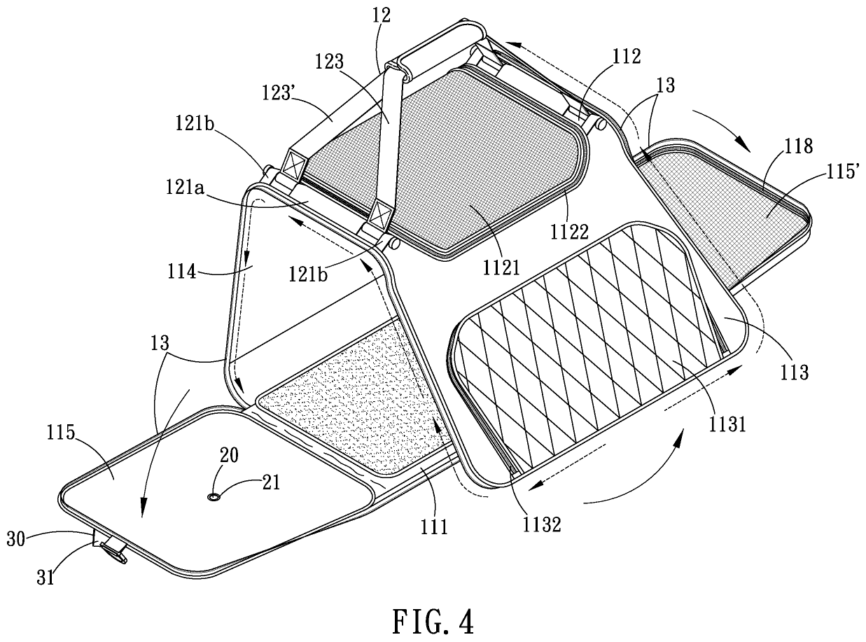

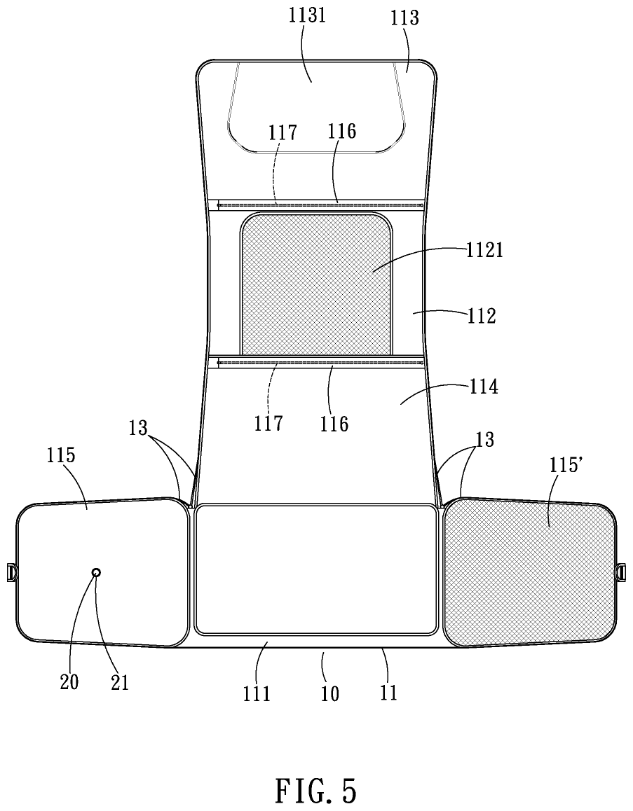

Please refer to FIG. 4 and FIG. 5. The carrier body 10 can be a rectangular carrier body or a semi-circular barrel-shaped carrier body, which specifically uses a soft cloth sheet to make a bottom sheet 111, a top sheet 112, a front sheet 113, a back sheet 114, and two side sheets 115, 115′. The bottom edge of the back sheet 114 is inseparably connected to the rear edge of the bottom sheet 111. The rear edge of the top sheet 112 is inseparably connected to the top edge of the back sheet 114. The top edge of the front sheet 113 is inseparably connected to the front edge of the top sheet 112.

Therefore, the front sheet 113, the top sheet 112, and the back sheet 114 can be flipped back and unfolded. The bottom edges of the two side sheets 115, 115′ are respectively inseparably connected to the two opposite lateral sides of the bottom sheet 111 so that the two side sheets 115,115′ can be flipped and unfolded on both sides.

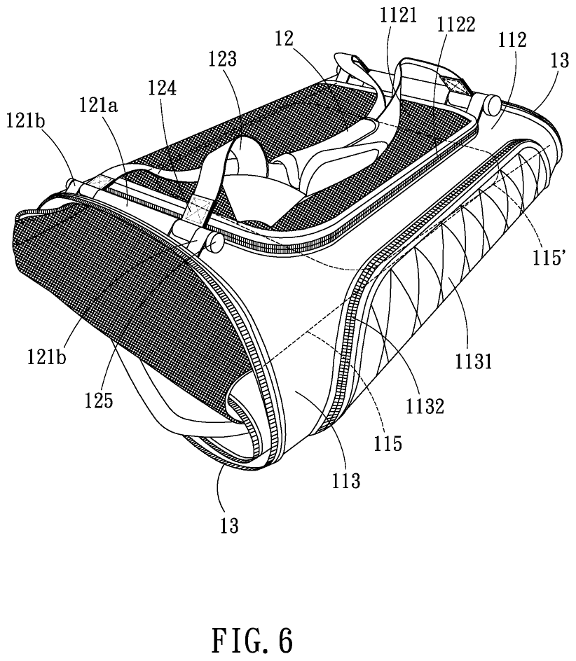

Referring to FIG. 1, FIG. 4 and FIG. 5, in order to facilitate the carrier body 10 to be folded or assembled into a pet box after being unfolded, the carrier body 10 described above preferably implements a first zipper 13. The first zipper 13 is stitched between the two opposite side edges of the back sheet 114 and the rear edges of the two side sheets 115,115′, and uninterruptedly extended and stitched to the two opposite side edges of the top sheet 112 and the top edges of the two side sheets 115, 115′, and then uninterruptedly extended and stitched to the two side edges of the front sheet 113 and the front edges of the two side sheets 115k,115′, and then uninterruptedly extended and stitched to the front edge of the bottom sheet 111 and the bottom edge of the front sheet 113. The first zipper 13 has two well-known zipper sliders (not shown) for users to slide. Therefore, when the first zipper 13 is fully pulled out in the direction of the back sheet 114 (as shown in the direction of the dashed arrow shown in FIG. 4), the carrier body 10 can be fully unfolded (as shown in FIG. 5), and then folded and compressed (as shown in FIG. 6). On the contrary, when the first zipper 13 is pulled together, the carrier body 10 can be combined into a rectangular carrier body. Please refer to FIG. 1 and FIG. 2 again. One of the two side sheets 115 and 115′, namely, the side sheet 115 is a single-layer or multi-layer non-porous fabric, and the drinking hole 20 and the elastic belt 31 are arranged on the non-porous fabric. Non-porous fabric has better support, can prevent the kettle from being pulled by its weight, and keep the sides flat. The other side sheet 115′ is a porous fabric, which can spy on pets and ventilate other side sheet 115′. The three edges of the side sheet 115′ of the porous fabric are provided with a second zipper 118 for separately opening the side sheet 115′ of the porous fabric. The top sheet 112 is provided with an upper cover 1121, and a third zipper 1122 sewn between the three sides of the upper cover 1121 and the upper opening of the top sheet 112. The upper cover 1121 can be made of single-layer or multi-layer non-porous fabric or a porous fabric. In addition, the front sheet 113is provided with a front cover 1131, and a fourth zipper 1132 sewn between the three sides of the front cover 1131 and the upper opening of the top sheet 112. The front cover 1131 can be made of single-layer or multi-layer non-porous fabric or a porous fabric.

Please refer to FIG. 3 again. In order to enable the portable device 12 on the carrier body 10 to stably lift the pet box 11, maintain the shape of the pet box 11 and avoid collapse or deformation, a preferred embodiment of the portable device 12 comprises a first arched piece 121a located on each of two opposite sides of the top surface of the pet box 11, and two second arched pieces 121b separated from two opposite ends of each first arched piece 121a by a distance. Each of the first arched pieces 121a and second arched pieces 121b is composed of a soft cloth or film, and its two sides are combined on the top surface of the pet box 11 by stitching or riveting structure and lean against the side of the pet box 11, so that each of the first arched pieces 121a and the second arched pieces 121b extends in the front and rear direction of the pet box 11. Two rod members 122 are respectively inserted in the first arched pieces 121a and the second arched pieces 121b (FIG. 3 shows on one side only, and the other side has the same structure). A front section of the rod member 122 protrudes from the front end of one second arched piece 121b, and a rear section of the rod member 122 protrudes from the rear end of the other second arched piece 12 lb. The portable device 12 further comprises two straps 123, 123′. The two ends of the one strap 123 (front strap) are respectively combined in the front sections of the two rod members 122, and the two ends of the other strap 123′ (rear strap) are respectively combined in the rear sections of the two rod members 122. Both ends of the strap 123, 123′ each have a connecting piece 124, and the connecting piece 124 is a cloth piece folded in half and stitched on both sides of the strap 123, 123′ to form a perforation 1241. The perforations 1241 are used to nest the front and rear sections of the rod member 122 respectively, and are set at the interval between the first arched piece 121a and the second arched pieces 12 lb. In addition, the front and rear sections of the rod member 122 are respectively locked with a screw 125, and the screw heads of the two screws 125 block the second arched pieces 121b to prevent the connecting pieces 124 from falling off. Thereby, the present invention, through the design of the first arched pieces 121a and the second arched pieces 121b at both ends, can prevent the lifting rod member 122 from shaking back and forth, and achieve the function of stably lifting the pet box 11.

In the present invention, the length of the first arched pieces 121a is greater than ½ of the depth dimension of the top surface of the pet box 11, and the length of the rod members 122 is approximately equal to the depth dimension of the top surface of the pet box 11. The straps 123, 123′ are respectively combined with the front and rear sections of the rod members 122, so that the straps 123, 123′ can be pulled up on both ends of the rod members 122 when they are held, and the rod members 122 will then stably support the first arched pieces 121a and second arched pieces 121b, so it can keep the pet box 11 stable. Furthermore, referring to FIG. 5, the front edge and rear edge of the inner surface of the top sheet 112 of the pet box 11 are sewn with a cloth strip 116 respectively. A support strip 117 is provided in each cloth strip 116. Both ends of the support strip 177 are adjacent to the two side sheets 115, 115′ of the pet box 11. In this way, a quadrilateral support structure is formed with the above-mentioned two rod members 122, which can keep the shape of the pet box 11 stable and prevent collapse and deformation when being lifted or shouldered.

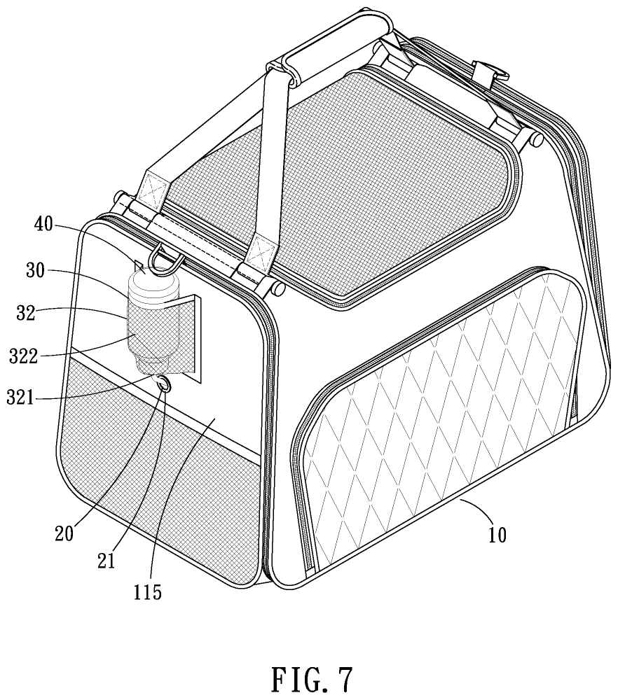

In addition, refer to FIG. 7 again. The kettle holder 30 of the present invention is not limited to the two elastic belts 31, 31′ mentioned above, and the kettle holder 30 can also be implemented as a kettle bag 32. The kettle bag 32 can be formed by stitching two opposite side edges and a bottom edge of a cloth piece on the outer surface of one side of the pet box 11. The bottom of the kettle bag 32 is provided with a through hole 321. In this way, the kettle 40 is placed in the kettle bag 32 in reverse, so that the dip tube 41 protrudes from the through hole 321, and then penetrates the above-mentioned drinking hole 20, which can also provide drinking water to pets. Moreover, the structure of the kettle bag 32 can prevent the kettle 40 from loosening. The kettle bag 32 is preferably composed of a mesh cloth 322, and the two opposite side edges and the bottom edge of the mesh cloth 322 are stitched on the outer surface of the side of the pet box 11, so that the water volume of the kettle 40 can be more conveniently observed from the outside.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A pet carrier used to carry pets out, comprising:
a carrier body comprising a pet box stitched by soft cloth pieces and a portable device combined with said pet box;
a drinking hole set on one side of said carrier body and connected to the inside of said carrier body, and used to provide a kettle of dip tube to extend into the inside of said carrier body through said drinking hole; and
a kettle holder set outside the side of said carrier body with said drinking hole, and used to install and fix a kettle.

2. The pet carrier as claimed in claim 1, wherein said kettle holder is composed of an elastic belt, said elastic belt being folded in half with two opposite ends thereof combined on an outer surface of the side of said carrier body with said drinking hole.

3. The pet carrier as claimed in claim 1, wherein said kettle holder is composed of two elastic belts, said two elastic belts having different lengths, said two elastic belts being folded in half with respective two opposite ends thereof combined on an outer surface of the side of said carrier body with said drinking hole, so that one said elastic belt has a larger diameter than the other said elastic belt.

4. The pet carrier as claimed in claim 3, wherein said elastic belts are elastic braided belts.

5. The pet carrier as claimed in claim 1, wherein said kettle holder is a kettle bag, said kettle bag being formed by stitching two side edges and a bottom edge of a cloth piece on the outer surface of the side of said carrier body with said drinking hole, said kettle bag comprising a through hole located on a bottom side thereof.

6. The pet carrier as claimed in claim 5, wherein said cloth piece of said kettle bag is a mesh cloth.

7. The pet carrier as claimed in claim 1, wherein said drinking hole has an edge thereof covered with a metal ring.

8. The pet carrier as claimed in claim 1, wherein said carrier body comprises a bottom sheet, a top sheet, a front sheet, a back sheet and two side sheets, said back sheet having a bottom edge thereof inseparably connected to a rear edge of said bottom sheet n rear edge, said top sheet having a rear edge thereof inseparably connected to a top edge of said back sheet and said front sheet having a top edge thereof inseparably connected to a front edge of said top sheet so that said back sheet, said top sheet and said front sheet are capable of being flipped back and unfolded, said two side sheets having a respective bottom edge thereof respectively inseparably connected to two opposite side edges of said bottom sheet so that said two side sheets are capable of being flipped to two opposite sides and unfolded.

9. The pet carrier as claimed in claim 8, wherein said carrier body comprises a first zipper, said first zipper being stitched between the two opposite side edges of said back sheet and rear edges of said two side sheets, and uninterruptedly extended and stitched to two opposite side edges of said top sheet and respective top edges of said two side sheets and then uninterruptedly extended and stitched to two side edges of said front sheet and respective front edges of said two side sheets', and then uninterruptedly extended and stitched to a front edge of said bottom sheet and a bottom edge of said front sheet, so that when said first zipper is opened, said carrier body is capable of being completely flattened out, and when said first zipper is closed, said carrier body is capable of being combined into a rectangular carrier body.

10. The pet carrier as claimed in claim 8, wherein one said side sheet is selectively a single layer or multilayer non-porous fabric, and said drinking hole and said elastic belt are provided on said non-porous fabric.

11. The pet carrier as claimed in claim 10, wherein the other said side sheet is a porous fabric.

12. The pet carrier as claimed in claim 11, wherein the porous fabric of the other said side sheet has three sides thereof provided with a second zipper.

13. The pet carrier as claimed in claim 8, wherein said top sheet is provided with an upper cover, and a third zipper sewn between three sides of said upper cover and an upper opening of said top sheet; said front sheet is provided with a front cover, and a fourth zipper sewn between three sides of said front cover and the upper opening of said front sheet.

14. The pet carrier as claimed in claim 13, wherein said upper cover is a porous fabric; said front cover is selectively a single layer or multilayer non-porous fabric.

15. The pet carrier as claimed in claim 1, wherein said portable device comprises:
a first arched piece located on each of two opposite sides of a top surface of said pet box;
two second arched pieces separated from two opposite ends of each said first arched piece by a distance, each of said first arched pieces and said second arched pieces extending the front and rear direction of said pet box;
two rod members respectively inserted in said first arched pieces and said second arched pieces, each said rod member having a front section thereof protruding from a front end of one said second arched piece and a rear section thereof protruding from a rear end of the other said second arched piece; and
two straps, one said strap having two opposite ends thereof respectively combined in the front sections of said two rod members, the other said strap having two opposite ends thereof respectively combined in the rear sections of said two rod members.

16. The pet carrier as claimed in claim 15, wherein both ends of each said strap are each provided with a connecting piece, said connecting piece being a cloth piece folded in half and stitched on both sides of the respective said strap to form a perforation, said perforations being used to nest the front and rear sections of said rod member respectively, said two connecting pieces being respectively set at the interval between said first arched pieces and said second arched pieces.

17. The pet carrier as claimed in claim 16, wherein the front and rear sections of said rod member are respectively locked with a screw, and respective screw heads of said screws block said second arched pieces.

18. The pet carrier as claimed in claim 15, wherein the length of said first arched pieces is greater than ½ of the depth dimension of the top surface of said pet box.

19. The pet carrier as claimed in claim 15, wherein said carrier body comprises a pet box composed of a bottom sheet, a top sheet, a front sheet, a back sheet and two side sheets; said top sheet having a front edge and a rear edge of an inner surface thereof respectively sewn with a cloth strip, each said cloth strip having a support strip set therein, said support strip having two opposite ends disposed adjacent to said side sheets of said pet box.
